(19) United States
(12) Patent Application Publication
(10) Pub. No.: US 2012/0094152 A1
(43) Pub. Date: Apr. 19, 2012

(54) METHOD AND DEVICE FOR CONTROLLING BATTERY HEATING

(76) Inventors: Guanglin WU, Shenzhen (CN); Jin Liu, Shenzhen (CN); Hao Zhang, Shenzhen (CN); Xi Shen, Shenzhen (CN)

(21) Appl. No.: 13/328,248

(22) Filed: Dec. 16, 2011

Related U.S. Application Data
(63) Continuation of application No. PCT/CN2010/073358, filed on May 28, 2010.

(30) Foreign Application Priority Data
Jun. 18, 2009 (CN) 200910147355.2
Jun. 18, 2009 (CN) 200910147356.7
Jun. 18, 2009 (CN) 200910147362.2

(51) Int. Cl. H01M 10/50; H01M 10/42

(52) U.S. Cl. 429/50; 429/62

(57) ABSTRACT

A method and a device for controlling battery heating is disclosed. The method comprises: starting battery heating when conditions for starting battery heating are met; and stopping battery heating when conditions for stopping battery heating are met. The conditions for stopping battery heating include at least one of the following: (a) an absorbed energy Q of the battery reaching a predetermined energy Q_{SET}; (b) a time period Tᵢ during which a discharging current I of the battery maintains constant (c) the discharging current I starting to decrease when a predetermined time period T_{SET} is reached; and (d) a heating time period T reaching a predetermined maximum heating time period Tₘₐₓ. The method and the device consider multiple conditions, for example, temperature, discharging current, battery State-of-Charge, heating time, etc. to determine when to stop battery heating, which may further enhance the operating efficiency and lifespan of the battery.

### CROSS-REFERENCE TO RELATED APPLICATION

This application is a continuation of International Application No. PCT/CN2010/073358, filed on May 28, 2010, which claims the benefit of priority to Chinese Patent Application No. 200910147356.7, filed Jun. 18, 2009, Chinese Patent Application No. 200910147355.2, filed Jun. 18, 2009, and Chinese Patent Application No. 200910147362.2, filed Jun. 18, 2009, the entire contents of which are incorporated herein by reference.

### FIELD

The present invention relates to battery temperature management, more particularly to a method and a device for controlling battery heating.

### BACKGROUND

Lithium ion batteries have high energy densities, zero memory effect, and low discharge rates, and are therefore ideal as power supplies in portable electronic devices and electric vehicles. Because electric vehicles and certain portable electronic devices may need to operate under adverse environmental conditions, the lithium ion batteries in the power supplies of these vehicles and devices have to be able to operate reliably in a multitude of different environments. For example, when the electric vehicles or the electronic devices operate in a low temperature environment, the lithium ion batteries should possess excellent low temperature charging and discharging characteristics in order to maintain the high output and input power performance similar to that under ambient operating conditions.

One of the issues that may affect battery performance at low temperatures pertains to lithium ion migration. Normally, when the lithium ion battery is charged in low temperature conditions, the lithium ion may have a low migrating rate, and may have difficulty intercalating into the negative electrode. On the other hand, it is relatively easy for the lithium ion to de-intercalate from the negative electrode and subsequently deposit lithium metal, thereby forming “lithium dendrites.” Reduction of the deposited lithium metal with the electrolyte may then take place, and form a new Solid Electrolyte Interface (SEI) film that covers an original SEI film. The additional SEI film may increase the impedance of the battery and enhance its polarization, and significantly decrease the capacity of the battery. This may cause short circuits in the battery, which may further result in safety accidents.

To avoid generating lithium dendrites and to maintain the battery capacity, it is important to control the migration of the lithium ion at low temperatures. Currently, there are two methods to control the lithium ion migration. The first method involves formulating internal electrochemical reactions in the battery to improve battery performance at low temperatures. The second method includes providing a heating device outside the battery to increase the temperature of the battery to an appropriate working temperature. This heating device is activated based on the temperature of the battery. If the temperature of the battery is below a first predetermined temperature, the heating device starts to heat the battery and stops heating when the temperature of the battery reaches a second predetermined temperature.

For example, Chinese Patent Application CN201038282Y discloses a lithium ion battery suitable for use in a low temperature environment, and comprises: a battery shell; a thermal insulation layer tightly attached around the battery shell; an electric core disposed within the battery shell; a heating assembly disposed between the electric core and the thermal insulation layer, and a control circuit coupled to the heating device and the electric core. When the internal temperature of the battery is below a first predetermined temperature, the electric core embedded in a heat conducting cartridge begins to heat. This heating is accomplished through a control assembly comprising a control circuit and a temperature control switch, and a heat supply assembly comprising a heat generating assembly and a heat conducting assembly. When the temperature of the battery exceeds a second predetermined temperature, the control circuit and the temperature control switch activate in conjunction to stop the heating.

Nevertheless, the conventional temperature control method disclosed in the above-mentioned prior art, by setting a second predetermined temperature to stop heating, may not be adaptable to all conditions. For example, when the battery is transferred from an internal current collector to other parts of the power supply assembly, the temperature of the battery may not stabilize within a short time and as a result, temperature hysteresis may occur. Therefore, relying solely on the temperature of the battery to determine when to stop heating may not suffice in effectively protecting the battery.

### SUMMARY

The present invention is directed to solve at least one of the problems relating to the existing battery temperature control methods as discussed above, by providing a method and a device for heating a battery that may protect the battery more effectively.

According to one embodiment, a method for controlling battery heating is provided, comprising: starting battery heating when conditions for starting battery heating are met; and stopping battery heating when conditions for stopping battery heating are met. The conditions for stopping battery heating include at least one of the following: (a) an absorbed energy Q of the battery reaching a predetermined energy Q_{SET}; (b) a time period Tᵢ during which a discharging current I of the battery maintains constant; (c) the discharging current I starting to decrease when a predetermined time period T_{SET} is reached; and (d) a heating time period T reaching a predetermined maximum heating time period Tₘₐₓ.

According to another embodiment, a method for controlling battery heating is provided, comprising: starting battery heating when conditions for starting battery heating are met; and stopping battery heating when conditions for stopping battery heating are met. The conditions for stopping battery heating include at least one of the following: (a) when a State-of-Charge (“SOC”) of the battery is the same or higher than a predetermined SOC_{SET}: a discharging current I of the battery reaching a rated current Iᵣ or a heating time period T reaching a first maximum heating time period T₁ₘₐₓ; and (b) when a SOC of the battery is lower than a predetermined SOC_{SET}: a time period Tᵢ during which a discharging current I of the battery maintains constant before a predetermined time period T_{SET} is reached, or the discharging current I starting to decrease when T_{SET} is reached, or a heating time period T reaching a second maximum heating time period T₂ₘₐₓ.

According to an embodiment, a device for controlling battery heating is provided, comprising: a battery heating unit for heating the battery; and a control unit connected with a control terminal of the battery heating unit, and configured to start the heating unit to heat the battery when conditions for starting battery heating are met, and to stop the heating unit from heating the battery when conditions for stopping battery heating are met. The conditions for stopping battery heating include at least one of the following: (a) an absorbed energy Q of the battery reaching a predetermined energy Q_{SET}; (b) a time period Tᵢ during which a discharging current I of the battery maintains constant; (c) the discharging current I starting to decrease when a predetermined time period T_{SET} is reached; and (d) a heating time period T reaching a predetermined maximum heating time period Tₘₐₓ.

According to a further embodiment, a device for controlling battery heating is provided, comprising: a heating unit for heating the battery; and a control unit connected with a control terminal of the heating unit and configured to start the heating unit to heat the battery when conditions for starting battery heating are met, and to stop the heating unit from heating the battery when conditions for stopping battery heating are met. The conditions for stopping battery heating include at least one of the following: (a) when a SOC of the battery is the same or higher than a predetermined SOC_{SET}: the discharging current I of the battery reaching a rated current Iᵣ or the heating time T reaching a first maximum heating time T₁ₘₐₓ; and (b) when a SOC of the battery is lower than a predetermined SOC_{SET}: a time period Tᵢ during which a discharging current I of the battery maintains constant before a predetermined time period T_{SET} is reached, or the discharging current I starting to decrease when T_{SET} is reached, or a heating time period T reaching a second maximum heating time period T₂ₘₐₓ.

Unlike conventional battery heating control methods which are based solely on temperature, the method and the device according to the present invention consider a plurality of factors, such as temperature, discharging current, battery SOC, heating time, etc. to determine when to stop battery heating. For example, in a SOC, the conditions for stopping battery heating may relate to the discharging current and the heating time for both the high and the low SOC, and may be further adapted for the requirements under different SOCs. Thus, the battery in a low temperature environment may be effectively heated to ensure good battery charging/discharging performance under an optimal working temperature. This prevents accidental damage to the battery, and greatly enhances the operating efficiency and lifespan of the battery.

### BRIEF DESCRIPTION OF THE DRAWINGS

The aforementioned aspects and advantages of the invention will become apparent in light of the following detailed descriptions and drawings:

FIG. 1 shows a flow chart for controlling battery heating according to an embodiment of the present invention;

FIG. 2 shows a flow chart for controlling battery heating according to a preferred embodiment of the present invention;

FIG. 3 shows a schematic diagram of the device for controlling battery heating according to an embodiment of the present invention;

FIG. 4 shows a schematic diagram of the device for controlling the battery heating according to a preferred embodiment of the present invention;

FIG. 5 shows a flow chart for controlling the battery heating according to another embodiment of the present invention;

FIG. 6 shows a flow chart for controlling the battery heating according to another preferred embodiment of the present invention; and

FIG. 7 shows a schematic diagram of the device for controlling battery heating according to another preferred embodiment of the present invention.

### DETAILED DESCRIPTION OF THE EMBODIMENTS

Reference will be made in detail to the embodiments as described herein with reference to the drawings. The embodiments are explanatory, illustrative, and used for general understanding of the present invention, and shall not be construed to limit the present invention. Same or similar elements, and elements having the same or similar functions are denoted by common reference numerals throughout the descriptions.

The term “battery” in the present invention may refer to a single cell, or a battery pack comprising a plurality of single cells. The components within a “battery” relate to either a single cell or a battery pack, depending on the context in which they are described. For example, in a single cell, the terms “positive electrode” and “negative electrode” refer to the positive electrode and the negative electrode of the single cell respectively, whereas in a battery pack, the terms “positive electrode” and “negative electrode” refer to the positive electrode and the negative electrode of the battery pack respectively.

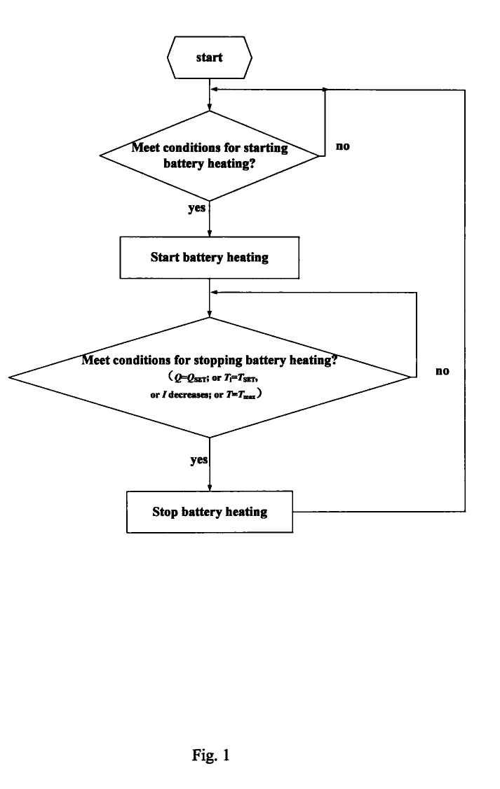

According to the embodiment as shown in FIG. 1, a method of controlling battery heating comprises: starting battery heating when conditions for starting battery heating are met; and stopping battery heating when conditions for stopping battery heating are met. The conditions for stopping battery heating include at least one of the following:
(a) an absorbed energy Q of the battery reaching a predetermined energy Q_{SET};
(b) a time period Tᵢ during which a discharging current I of the battery maintains constant;
(c) the discharging current I starting to decrease when a predetermined time period T_{SET} is reached; and
(d) a heating time period T reaching a predetermined maximum heating time period Tₘₐₓ.

The battery heating may be stopped as long as one or more of the above conditions is met.

As shown in FIG. 5, the controlling method according to another embodiment of the present invention comprises: starting battery heating when conditions for starting battery heating are met; and stopping battery heating when conditions for stopping battery heating are met. The conditions for stopping battery heating include at least one of the following: (a) when a SOC of the battery is the same or higher than a predetermined SOC_{SET}: the discharging current I of the battery reaching a rated current Iᵣ or the heating time period T reaching a first maximum heating time period T₁ₘₐₓ; and (b) when a SOC of the battery is lower than a predetermined SOC_{SET}: a time period Tᵢ during which a discharging current I of the battery maintains constant before a predetermined time period T_{SET} is reached, or the discharging current I starting to decrease when T_{SET} is reached, or the heating time period T reaching a second maximum heating time period T₂ₘₐₓ. The battery heating may be stopped as long as one or more of the above conditions is met.

The parameters in the aforementioned conditions for stopping battery heating will be described in detail as follows.

The SOC of the battery is the percentage of the actual remaining electricity quantity over the electricity quantity of a fully charged battery. According to an embodiment of the present invention, it may be calculated based on an open circuit voltage (OCV).

The SOC_{SET} may be preset according to practical requirements, and may be used to distinguish a high SOC from a low SOC. According to an embodiment of the present invention, the SOC may range from about 50% to 90%, preferably about 60%. In this embodiment, when SOC≧60%, the battery is in the high SOC; and when SOC<60%, the battery is in the low SOC.

The rated current Iᵣ may be determined based on the different nominal capacities of a battery. For example, for a battery having a nominal capacity of 50 Ah, Iᵣ may be about 2600 A; and for a battery having a nominal capacity of about 200 Ah, Iᵣ may be about 8000 A.

T₁ₘₐₓ may depend on the longest allowable heating time period under the high SOC condition, and may be about 30-120s.

T₂ₘₐₓ may depend on the longest allowable heating time period under the low SOC condition, and may be about 30-360s.

The heating time period T may be obtained during actual operation, and may be recorded from the time when the battery starts to heat. However, when the duration for heating is set such that it does not exceed the first heating time period T₁ₘₐₓ or the second heating time period T₂ₘₐₓ, the heating time period T may not need to be recorded.

The absorbed energy Q is the energy absorbed by the battery during heating, and is measured in Joules (J).

The predetermined energy Q_{SET} may be determined based on the heating temperature K of the battery. According to an embodiment of the invention, Q_{SET} may be calculated using the following equation:

Q_{SET}=cm (K_{STOP}−K_{START})

where c represents a specific heat of the battery in J/(kg·° C.), and may be obtained by accumulating the weighted mass fractions of the positive material, the negative material, the electrolyte, and other material compositions using the equation

$$c = {\sum }_{i = 1}^{n} {c}_{i} {w}_{i} ,$$

where cᵢ represents the specific heat of each material composition in the battery, and wᵢ represents the mass fraction of each material composition;

m refers to the mass of the battery in Kg, and may be obtained by measuring and calculating the average mass of a plurality of batteries of the same type;

K_{START} represents the temperature in ° C. at which heating starts, and ranges from about −50° C. to 0° C. ; K_{STOP} represents the temperature in ° C. for stopping battery heating, and ranges from about 0° C. to 25° C.; and K_{START}<K_{STOP}.

The discharging current I may be obtained during actual operation of the battery, and may be measured using a Hall current sensor.

The predetermined maximum heating time period Tₘₐₓ may be determined based on the maximum allowable heating time period, and may be about 30s-360s.

The heating time period may be measured during actual operation of the battery, and may be recorded from the time when battery heating starts. However, by setting the duration for heating such that it does not exceed the first heating time period T₁ₘₐₓ or the second heating time period T₂ₘₐₓ, the heating time period T may not need to be recorded.

The time period Tᵢ in which the discharging current I maintains constant may be measured during actual operation of the battery. For example, a Hall current sensor may be used to measure the discharging current, and the time period Tᵢ may be obtained by recording the time period during which the discharging current I is constant.

The predetermined time period T_{SET} may be set based on practical requirements, and ranges from about 10-30s, preferably about 30s.

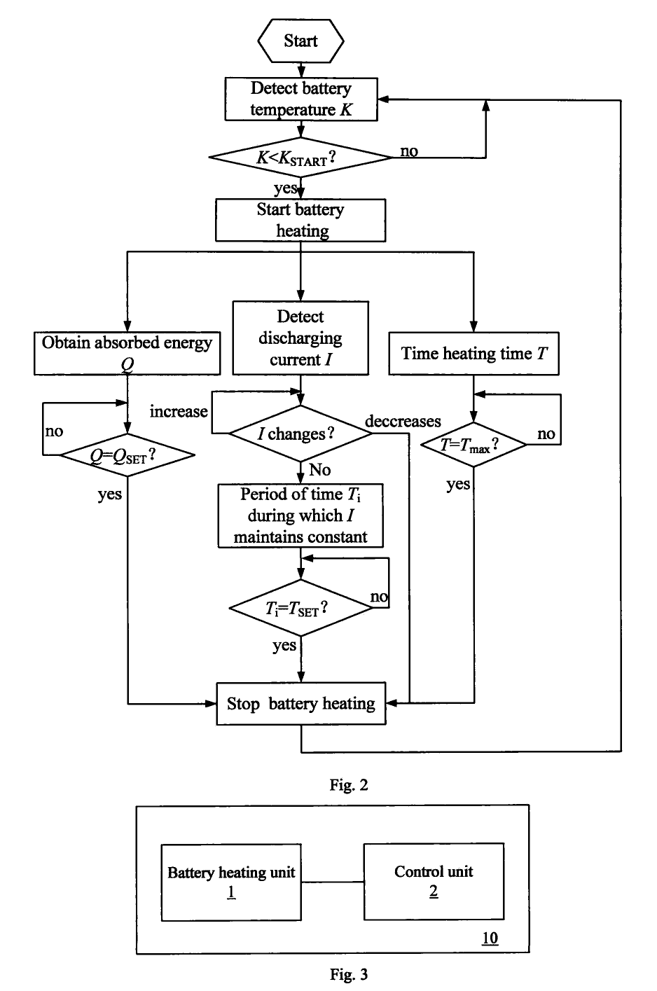

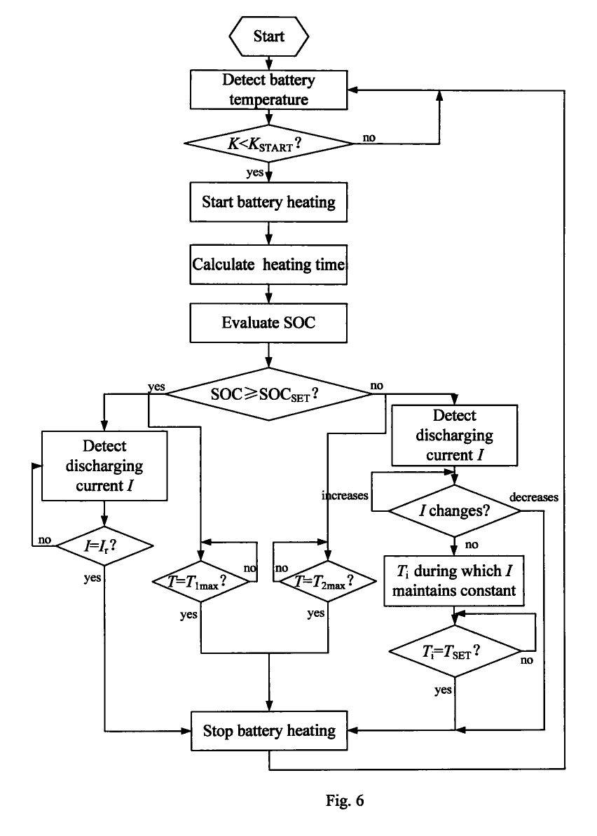

Some preferred embodiments will be described below with reference to FIG. 2 and FIG. 6.

First, the conditions for starting to heat are not limited, and a variety of suitable conditions for starting to heat may be used in addition or in the alternative. For example, as shown in FIG. 2 and FIG. 6, the battery heating may start when the temperature K of the battery is lower than a predetermined temperature K_{START}. A temperature sensor may be used to detect the battery temperature K. For a battery pack comprising a plurality of single cells, a plurality of temperature sensors may be used to detect the temperature of each cell, with the lowest detected cell temperature selected as the battery temperature K.

The heating method may include any suitable heating method discussed in the prior art. For example, an electric heating device may be used for heating. According to an embodiment of the present invention, a short circuit in the battery may be used to create high current so as to increase the temperature of the battery. A short circuit may be realized by a switch module, for example, an insulated gate bipolar transistor (IGBT) module, connected between the positive electrode and the negative electrode of the battery. By turning on the switch module, a short circuit of the battery occurs almost instantaneously.

When a short circuit is used for heating, the energy Q absorbed by the battery may be obtained by calculating a released energy Q_{D} during discharge of the short circuit using the following equation:

Q_{D}=I² Rt
in which I represents the discharging current of the battery in A (Ampere);
t represents the discharging time in s (second);
R represents the internal resistance of the battery, which may vary depending on the temperature K according to the equation R=a+be^{-cK}, in which a, b, and c represent the parameters for a specific type of battery. For example, a test method for determining the parameters may comprise keeping batteries of the same type at a certain temperature (−40° C. to 40° C.) for at least about 4 hours to allow the temperature of the battery to stabilize, using a current with a frequency of 1 KHz to measure the alternating current (AC) internal resistance, and repeating the above for different battery temperatures so that the measured internal resistance at different battery temperatures may be fitted to the equation R=a+be^{-cK}. Depending on the battery type, parameter a may range from 0.1 to 0.5, parameter b from 0.01 to 0.1, and parameter c from 0.05 to 0.1. For example, the following parameters may be obtained from the testing of a certain type of battery: a=0.5, b=0.1, and c=0.1.

The internal resistance equation may be substituted into the equation for Q_{D}, and after performing quadratic integration to t and K, the following equation may be obtained:

Q_{D}∫∫I²(a+be^{-cK})tdtdK

The sampling periodicity may be 0.1s, 0.2s, 0.5s, or 1s in the quadratic integration to obtain Q_{D},. When Q_{D} reaches the predetermined Q_{SET}, the conditions for stopping battery heating may be satisfied.

To avoid unnecessary damage to the battery due to the length of the short circuit heating, the time for turning on and off the switch module may need to be controlled. For example, turning on and off the switch module may be triggered by a pulse sequence, in which the pulse width may be about 1-3 ms, preferably about 1-2 ms. The duty ratio may be about 5-30%, preferably about 5-10%. The duration may range from about 30s to the predetermined maximum heating time period Tₘₐₓ, preferably about 60-360s.

When heating starts, the heating time period T may be recorded from the beginning to compare against a predetermined maximum heating time period Tₘₐₓ. However, this recording step may be omitted if the heating time period T is set to be less than the predetermined maximum heating time period Tₘₐₓ.

According to an embodiment of the present invention, the absorbed energy Q, the discharging current I, or the heating time T of the battery may be measured during the heating of the battery. The conditions for stopping battery heating may be determined according to the detailed flow chart shown in FIG. 2. When one or more of the conditions is met, the heating of the battery may be stopped to prevent degradation of the battery's performance and lifespan. The flow chart shown in FIG. 2 is not exclusive and those skilled in the art may design other flows according to the conditions disclosed in the present invention.

According to another embodiment, the battery SOC, the discharging current, or the heating time period T of the battery may be measured during the heating of the battery. The conditions for stopping battery heating may be determined according to the detailed flow chart shown in FIG. 6. When one or more of the conditions is met, the heating of the battery may be stopped to prevent degradation of the battery's performance and lifespan. The flow chart shown in FIG. 6 is not exclusive and those skilled in the art may design other flows according to the conditions disclosed in the present invention.

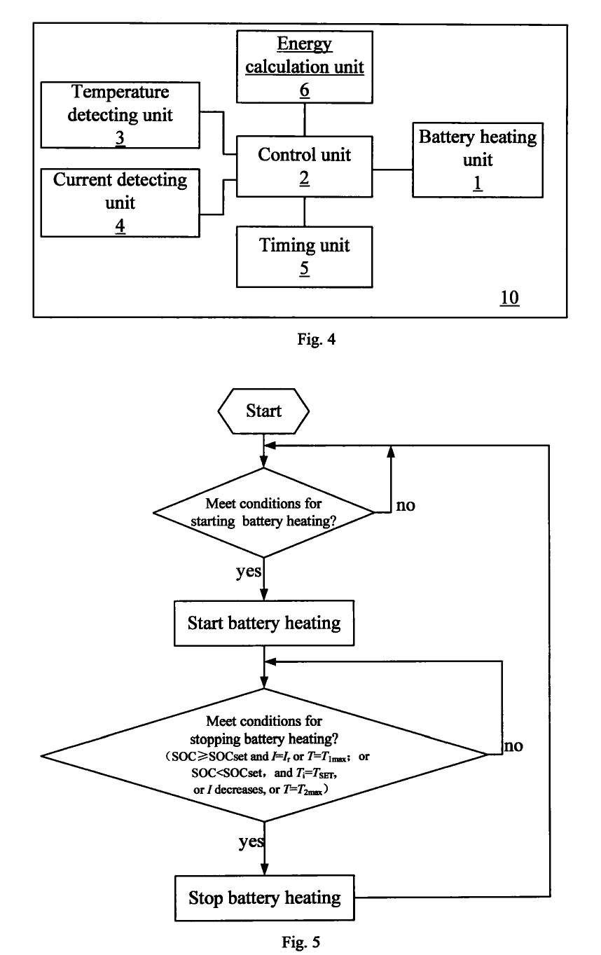

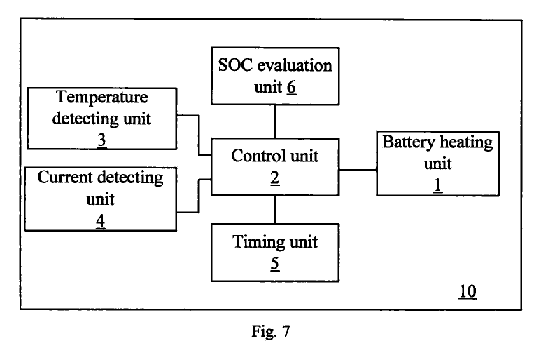

The device for controlling the heating of the battery is further described in FIG. 3, FIG. 4, and FIG. 7.

As shown in FIG. 3, according to an embodiment of the present invention, a device 10 for controlling the heating of the battery comprises: a battery heating unit 1 for heating the battery; and a control unit 2 connected with a control terminal of the heating unit 1, and configured to start the heating unit 1 to heat the battery when conditions for starting battery heating are met, and stop the heating unit 1 from heating the battery when conditions for stopping battery heating are met. The conditions for stopping battery heating may include at least one of the following: (a) an absorbed energy Q of the battery reaching a predetermined energy Q_{SET}; (b) a time period Tᵢ during which a discharging current I of the battery maintains constant before a predetermined time period T_{SET} is reached; (c) the discharging current I starting to decrease when the predetermined time period T_{SET} is reached; and (d) a heating time period T reaching a predetermined maximum heating time period Tₘₐₓ.

According to another embodiment of the present invention, the conditions for stopping battery heating include: (a) when a SOC of the battery is the same or higher than a predetermined SOC_{SET}: the discharging current I of the battery reaching a rated current Iᵣ or the heating time period T reaching a first maximum heating time period T₁ₘₐₓ; and (b) when a SOC of the battery is lower than a predetermined SOC_{SET}: a time period Tᵢ during which a discharging current I of the battery maintains constant before a predetermined time period T_{SET} is reached, or the discharging current I starting to decrease when the predetermined time period T_{SET} is reached, or the heating time period T reaching a second maximum heating time period T₂ₘₐₓ.

The battery heating unit 1 may be any heating device suitable for the battery. For example, a conventional electric heating device, such as an electric heating wire, may be used. However, this type of heating device may occupy a large space and increase the volume of the battery assembly. Therefore, the electric device or equipment may need relatively more space for accommodating the battery.

To solve the above mentioned problem, the heating unit 1 according to an embodiment of the present invention may comprise a switch module connected between the positive electrode and the negative electrode. When the switch module is turned on, short circuit of the battery may then take place. The switch module itself may not have a heating function for the battery, but by turning on the switch module, an internal short circuit of the battery may occur instantaneously and create a high current, which generates heat and increases the temperature of the battery. Unlike a conventional electric heating device, the switch module may have a simpler structure and a smaller volume, and may be adapted to an electric device or equipment with limited space.

The switch module may be any switch circuit, for example, a triode or a MOS transistor, that creates a short circuit through a pulse, and that does not damage the battery nor affect the battery performance.

According to a particular embodiment, the switch module may be a IGBT module having a drain, a source, and a grid. The drain (i.e. the control terminal) may be connected with a control unit 2, the source may be connected with the positive electrode or the negative electrode, and the drain may be connected with either the negative electrode and the positive electrode (depending on the P or N type of the IGBT). The IGBT module has the advantages of both the power field effect transistor and the electronic transistor, such as high input impedance, fast working speed, excellent heat stability, simple driving circuit, low on-state voltage, high voltage durability, and high current durability. In addition, the switch module may comprise a plurality of IGBT modules connected in parallel, one of which may be turned on to create the short circuit.

Suitable IGBT modules having proper withstanding voltage or current may be selected by those skilled in the art according to different types or the designed capacities of the batteries. For example, an IGBT having a voltage duration value above 1000 V, preferably above 1200 V, may be selected. According to another particular embodiment, when the designed capacity is below 100 Ah, an IGBT with a current duration value of 3000-5000 A may be used; and when the designed capacity of the battery is above 100 Ah, an IGBT with a current duration value of about 5000-10000 A may be used.

As shown in FIG. 3, a control unit 2 may control the heating of the battery heating unit 1 by sending control signals to the battery heating unit 1. For example, a Single Chip Microcomputer (SCM), a Digital Signal Processor (DSP), and so forth, may be selected to be the control unit 2 depending on the battery heating unit 1.

According to an embodiment of the present invention, when a switch module is used in the heating method, the control unit 2 may be a pulse generator capable of generating a pulse sequence that forms the output to the control terminal of the switch module to turn on or off the switch module. To avoid unnecessary damage to the battery due to the lengthy duration of the short circuit, the time for turning on and off the switch module may need to be controlled, and the turning on and off of the switch module may be triggered by the pulse sequence. According to an embodiment of the invention, the pulse width may be about 1-3 ms, preferably about 1-2 ms. The duty ratio may be about 5-30%, preferably about 5-10%. The duration may range from about 30s to the predetermined maximum heating time period Tₘₐₓ, preferably about 60-360s.

When generating a control signal, the control unit 2 may need to determine whether the conditions for starting or stopping the heating of the battery are met.

The conditions for starting battery heating are not limited, and a variety of suitable conditions for starting battery heating may be used. For example, when the temperature K of the battery is lower than a predetermined temperature K_{START}, the heating of the battery may be started when K_{START} is less than K_{STOP}, and where K_{START} may range from about −50° C. to about 0° C. In this case, the battery temperature K may need to be detected. According to an embodiment of the present invention, as shown in FIG. 4 and FIG. 7, the device 10 for controlling the heating of the battery may further comprise a temperature detecting unit 3 connected with the control unit 2, and may be configured to detect the battery temperature K and output the detected temperature K to the control unit 2. The received temperature K may then be compared with the temperature K_{START} in the control unit 2, which determines whether to start battery heating based on the comparison result. The temperature detecting unit 3 may be any temperature sensing device. According to an embodiment of the invention, a temperature sensor may be used. According to another embodiment of the invention, the number of temperature sensors may be the same as that of the single cells. When the control unit 2 receives a plurality of detected temperatures, the lowest detected temperature may be selected as the battery temperature K.

The present invention is mainly directed to improve the conditions for stopping battery heating. When the control unit 2 determines the conditions for stopping battery heating, information relating to the absorbed energy Q, the SOC, the discharging current I, or the heating time period T of the battery may be required. Therefore, according to some embodiments of the invention, the device 10 for controlling battery heating may further comprise some units or devices for obtaining the above information.

According to an embodiment of the present invention, the following processes may be performed by the control unit 2.

First, the control unit 2 may need to determine when the absorbed energy Q reaches the predetermined energy Q_{SET}. In this case, the device 10 may further comprise an energy calculation unit 6 connected with the control unit 2 for calculating the absorbed energy Q of the battery and sending the calculated result to the control unit 2. The calculation of the absorbed energy Q is the same as that described in the above method and is omitted herein for clarity. When the control unit 2 determines that the absorbed energy Q has reached the predetermined energy Q_{SET}, the control unit 2 immediately outputs a control signal for stopping battery heating.

Second, the control unit 2 may need to detect the discharging current I. As shown in FIG. 4, the device 10 may further comprise a current detecting unit 4 connected with the control unit 2 for detecting the discharging current I of the battery and sending the detected result to the control unit 2. The control unit 2 may determine whether the detected discharging current I is changing, and if the detected discharging current I is not changing, the control unit 2 starts to record the time period Tᵢ during which the discharging current I maintains constant. If Tᵢ reaches a predetermined time period T_{SET}, the control unit 2 may output a control signal for stopping battery heating. If I starts to decrease, the control unit 2 may also output a control signal for stopping battery heating. The current detecting unit 4 may be any kind of device that is capable of detecting a current. Particularly, a Hall current sensor may be used.

In addition, the control unit 2 may further determine when to stop battery heating according to the heating time period T using the two methods shown in FIG. 4.

In the first method, the device 10 may comprise a timing unit 5 connected with the control unit 2 for recording the heating time period T of the heating unit 1 under the control of the control unit 2, and sending a signal to the control unit 2 when T reaches the predetermined maximum heating time period Tₘₐₓ. The control unit 2 may output a control signal for stopping battery heating instantaneously when the signal is received.

In the second method, the duration of the pulse sequence generated by the control unit 2 is set to be less than the predetermined maximum heating time period Tₘₐₓ. When the heating time period T reaches the maximum heating time period Tₘₐₓ, the battery heating may automatically stop.

According to another embodiment of the present invention, the following processes may be performed by the control unit 2.

The control unit 2 determines whether the battery is in a high SOC or a low SOC. In this case, as shown in FIG. 7, the device 10 may further comprise a SOC evaluation unit 6 connected with the control unit 2 for evaluating the SOC of the battery and sending the evaluation result to the control unit 2. The control unit 2 may determine whether the battery is in a high SOC or a low SOC after comparing the received SOC with the SOC_{SET}. The SOC evaluation unit 6 may use any known SOC evaluation methods, for example, evaluating the battery SOC based on the open circuit voltage of the battery.

If the battery is in a high SOC, the control unit 2 may further detect the discharging current I. As shown in FIG. 4, the device 10 may further comprise a current detecting unit 4 connected with the control unit 2 for detecting the discharging current I of the battery and sending the detection result to the control unit 2. The control unit 2 may compare the discharging current I with the rated current Iᵣ, and if I reaches Iᵣ, the control unit may output a control signal for stopping battery heating. The current detecting unit 4 may be any device which is capable of detecting the current, such as a Hall current sensor.

If the battery is in a low SOC, the control unit may further detect the discharging current I by the current detecting unit 4. The control unit 2 may determine whether the detected discharging current I is changing. If the detected discharging current I is not changing, the control unit 2 may then start to record the time period Tᵢ during which the discharging current I maintains constant. If Tᵢ reaches a predetermined time period T_{SET}, the control unit 2 may output a control signal for stopping battery heating. If the discharging current I starts to decrease, the controlling unit 2 may also output a control signal for stopping battery heating.

In addition, the control unit 2 may determine whether to stop battery heating according to the heating time period based on the following two methods.

First, as shown in FIG. 4, the device 10 may further comprise a timing unit 5 connected with the control unit 2 for calculating the heating time period T of the heating unit 1 controlled by the control unit 2, and outputting a signal to the control unit 2 when T reaches the first maximum heating time period T₁ₘₐₓ or the second maximum heating time period T₂ₘₐₓ. The control unit 2 may output a control signal for stopping battery heating according to the received signal.

Second, the control unit 2 may directly set a duration for the pulse sequence after comparing the battery SOC with the SOC_{SET}. For a high SOC (SOC≧SOC_{SET}), the duration may not exceed the first maximum heating time period T₁ₘₐₓ, and for a low SOC (SOC<SOC_{SET}), the duration may not exceed the second maximum heating time period T₂ₘₐₓ. When the heating time period T reaches the first maximum heating time period or the second maximum heating time period, the heating of the battery may stop automatically.

Although explanatory embodiments have been shown and described, it would be appreciated by those skilled in the art that changes, alternatives, and modifications all falling into the scope of the claims and their equivalents may be made in the embodiments without departing from spirit and principles of the invention.

What is claimed is:

1. A method for controlling battery heating, comprising:
starting battery heating when conditions for starting battery heating are met; and
stopping battery heating when conditions for stopping battery heating are met;
wherein conditions for stopping battery heating include at least one of the following:
an absorbed energy Q of the battery reaching a predetermined energy Q_{SET};
a time period Tᵢ during which a discharging current I of the battery maintains constant;
the discharging current I starting to decrease when a predetermined time period T_{SET} is reached; or
a heating time period T reaching a predetermined maximum heating time period Tₘₐₓ.

2. The method according to claim 1, wherein the predetermined time period T_{SET} is about 10s to 30s, and the predetermined maximum heating time period Tₘₐₓ is about 30s to 360s.

3. The method according to claim 1, wherein the predetermined energy Q_{SET} is calculated based on a battery heating temperature K.

4. The method according to claim 1, wherein the predetermined energy Q_{SET} is calculated by the following equation:
Q_{SET}=cm(K_{STOP}−K_{START})
where c represents the specific heat in J/(kg·° C.);
m represents a mass of the battery in Kg;
K_{START} represents the temperature for starting battery heating, and ranges from about −50° C. to 0° C.;
K_{STOP} represents the temperature for stopping battery heating, and ranges from about 0° C. to 25° C. ; and
K_{START} is less than K_{STOP}.

5. The method according to claim 1, further comprising:
turning on a switch module connected between a positive electrode and a negative electrode to cause short circuit of the battery to increase the temperature thereof.

6. The method according to claim 5, wherein the absorbed energy Q is obtained by calculating a released energy Q_{D} during battery discharging upon short circuit

7. The method according to claim 5, wherein turning on the switch module is triggered by a pulse sequence with a pulse width of about 1 ms to 3s, a duty ratio of about 5% to 30%, and a duration ranging from about 30s to the predetermined maximum heating time period Tₘₐₓ.

8. The method according claim 1, wherein the conditions for stopping battery heating further comprise at least one of the following:
when a SOC of the battery is the same or higher than a predetermined SOC_{SET},:
the discharging current I of the battery reaching a rated current Iᵣ; or
the heating time period T reaching a first maximum heating time period T₁ₘₐₓ; and
when a SOC of the battery is lower than a predetermined SOC_{SET}:
a time period Tᵢ during which a discharging current I of the battery maintains constant before a predetermined time period T_{SET} is reached; or
the discharging current I starting to decrease when the predetermined time period T_{SET} is reached; or
the heating time period T reaching a second maximum heating time period T₂ₘₐₓ.

9. The method according to claim 8, wherein the SOC_{SET} is about 50% to 90%, the T_{SET} is about 10s to 30s, the first maximum heating time period T₁ₘₐₓ is about 30s to 20s, and the second maximum heating time period T₂ₘₐₓ is about 30s to 360s.

10. A method for heating a battery, comprising:
starting battery heating when conditions for starting battery heating are met; and
stopping battery heating when conditions for stopping battery heating are met;
wherein conditions for stopping battery heating include at least one of the following:
when a SOC of the battery is the same or higher than a predetermined SOC_{SET}:
a discharging current I of the battery reaching a rated current Iᵣ; or
a heating time T reaching a first maximum heating time period T₁ₘₐₓ; and
when a SOC of the battery is lower than a predetermined SOC_{SET}:
a time period Tᵢ during which a discharging current I of the battery maintains constant before a predetermined time period T_{SET} is reached; or
the discharging current I starting to decrease when the predetermined time period T_{SET} is reached; or
a heating time period T reaching a second maximum heating time period T₂ₘₐₓ.

11. The controlling method according to claim 10, wherein the SOC_{SET} is about 50% to 90%, the T_{SET} is about 1 Os to 30s, the first maximum heating time period T₁ₘₐₓ is about 30s to 120s, and the second maximum heating time period T₂ₘₐₓ is about 30s to 360s.

12. A device for controlling battery heating, comprising:
a battery heating unit for heating the battery; and
a control unit connected to a control terminal of the battery heating unit, and configured to start the heating unit to heat the battery when conditions for starting battery heating are met, and to stop the heating unit from heating the battery when conditions for stopping battery heating are met, wherein conditions for stopping battery heating include at least one of the following:
an absorbed energy Q of the battery reaching a predetermined energy Q_{SET};
a time period Tᵢ during which a discharging current I of the battery maintains constant before a predetermined time period T_{SET} is reached;
the discharging current I starting to decrease; or
a heating time period T reaching a predetermined maximum heating time period Tₘₐₓ.

13. The device according to claim 12, wherein the predetermined time period T_{SET} is about 10s-30s, and the predetermined maximum heating time period Tₘₐₓ is about 30s to 360s.

14. The device according to claim 12, wherein the predetermined energy Q_{SET} is calculated based on a battery heating temperature K.

15. The device according to claim 12, wherein the predetermined energy Q_{SET} is calculated using the following equation:
Q_{SET}=cm(K_{STOP}−K_{START})
where c represents the specific heat in J/(kg·° C.);
m represents a mass of the battery in Kg;
K_{START} represents the temperature for starting battery heating, and ranges from about −50° C. to 0° C.;
K_{STOP} represents the temperature for stopping battery heating, and ranges from about 0° C. to 25° C. ; and
K_{START} is less than K_{STOP}.

16. The device according to claim 12, wherein the battery heating unit comprises a switching module connected between a positive electrode and a negative electrode, wherein turning on the switching module causes short circuit of the battery to increase the temperature thereof.

17. The device according to claim 16, wherein the absorbed energy Q is obtained by calculating a released energy Q_{D} during battery discharging upon the short circuit.

18. The device according to claim 12, further comprising:
an energy calculation unit connected with the control unit for calculating the absorbed energy Q of the battery and sending the calculated Q value to the control unit;
a current detecting unit connected with the control unit for detecting the discharging current I and sending the detected I value to the control unit; and
a timing unit connected with the control unit for calculating the heating time period T of the heating unit under the control of the control unit, and outputting a signal to the control unit when T reaches the predetermined maximum heating time period Tₘₐₓ;
wherein the control unit is further configured to:
compare the absorbed energy Q with a predetermined energy Q_{SET}, and to output a control signal for stopping battery heating when the absorbed energy Q reaches the predetermined energy Q_{SET};
determine whether the discharging current I is changing according to the detected discharging current I, start recording the time period Tᵢ when the discharging current I becomes constant, and output a control signal for stopping battery heating when the time period Tᵢ reaches a predetermined time period T_{SET}; and
output a control signal for stopping battery heating when the discharging current I starts to decrease.

19. The device according to claim 12, wherein the conditions for stopping battery heating further comprise at least one of the following:
when a SOC of the battery is the same or higher than a predetermined SOC_{SET}:
the discharging current I of the battery reaching a rated current Iᵣ; or
the heating time period T reaching a first maximum heating time period T₁ₘₐₓ; and
when a SOC of the battery is lower than a predetermined SOC_{SET}:
a time period Tᵢ during which a discharging current I of the battery maintains constant before a predetermined time period T_{SET} is reached; or
the discharging current I starting to decrease when the predetermined time period T_{SET} is reached; or
the heating time period T reaching a second maximum heating time period T₂ₘₐₓ.

20. The device according to claim 12, wherein the control unit is a pulse generator for generating and outputting a pulse sequence to the control terminal of the switch module to turn on or off the switch module.
